(19) United States
(12) Patent Application Publication
(10) Pub. No.: US 2014/0035244 A1
(43) Pub. Date: Feb. 6, 2014

(54) Antitheft Device For Shopping Carts

(71) Applicant: David P. Bello, Newberry, FL (US)

(72) Inventor: David P. Bello, Newberry, FL (US)

(21) Appl. No.: 13/563,691

(22) Filed: Jul. 31, 2012

(51) Int. Cl. B62D 25/24

(52) U.S. Cl. 280/33.994

(57) ABSTRACT

A security lid that converts the upper shopping cart storage area into an enclosed secure storage area for valuables. The lid can be rigid, and sized to fit one or more shopping cart types, and alternatively, it can be fabricated from foldable or flexible materials that allow it to be carried in the handbag of a customer. It has a variety of optional attachment devices that secure it to a conventional shopping cart.

### BACKGROUND

1. Technical Field

This invention relates in general to shopping carts, and more particularly it relates to antitheft devices for use with shopping carts.

2. Background of the Invention

Most individuals use shopping carts in a variety of commercial applications, including grocery stores, drug stores, discount stores, wholesale stores, home and garden stores, or any other environment that requires a conventional shopping cart. A substantial majority of all shopping carts typically contain a pivoting rear wall which, when extended, provides an upper shelf near the handle that allows items such as handbags to be stored while shopping.

For women shoppers, conventional shopping carts present a theft hazard because a handbag or other valuable item might be stolen while the shopper is distracted looking at inventory items on shelves, counters, etc. It would be desirable to have a method of protecting customer valuables while the customer's attention is directed away from their valuables to items on shelves, etc.

Further, it would be desirable to have a device that could not only be provided to a new shopping cart during the manufacturing process, but also can be provided as an add-on feature for pre-existing shopping carts. In either case, whether the device is factory pre-installed, or an after market device, it would be desirable that the device not interfere or prevent the stacking of shopping carts at the merchant's place of business.

Another advantage on the consumer would be to have a detachable antitheft device that the customer could own and attach to a variety of shopping cart sizes and configurations.

While the prior art has provided a basic raised platform for holding valuable or personal items, it has failed to provide a secure antitheft mechanism that can be attached to a shopping cart such that the shopping cart is provided with secure storage for valuables while the customer is shopping.

### SUMMARY OF THE INVENTION

This invention provides a permanently attached, or detachable security lid that converts the upper shopping cart storage area into an enclosed secure storage area for valuables. The lid can be rigid, and besides to fit one or more shopping cart types, and alternatively, it can be fabricated from foldable or flexible materials that allow it to be carried in the handbag of a customer. It has a variety of optional attachment devices that secure it to a conventional shopping cart.

### BRIEF DESCRIPTION OF THE DRAWINGS

FIG. 1 is a perspective view of a prior art shopping cart.

FIG. 2A is a top plan view of a preferred embodiment of the security lid.

FIG. 2B is an end view of the security lid that illustrates the outer bracket with a rod that has an attachment hook extending from it.

FIG. 2C illustrates an end view of the security lid that shows the bracket and the rotatable hook.

FIG. 3 shows a perspective view of a preferred embodiment of a security lid secured to a conventional shopping cart in the closed position.

FIG. 4 shows a perspective view of a preferred embodiment of a security lid secured to a conventional shopping cart in the open position.

### DETAILED DESCRIPTION OF THE PREFERRED EMBODIMENT

Prior to a discussion of the figures, an overview of the invention will be presented. The invention provides a security lid for an upper shopping cart storage area that can be fabricated as part of the shopping cart, or alternatively, fabricated as an independent add-on device that a business can attach to its shopping carts, or fabricated as a detachable security lid that a customer can attach to a shopping cart. The detachable embodiment of the security lid can be provided by the merchant or be a security lid owned by the customer who brings it to the merchant's location in the event that the merchant does not provide a security lid.

The security lid can be fabricated from any suitable material, such as metal, wire, cloth, wood, synthetic material (e.g., nylon, polyethylene, etc.). Likewise, it can be fabricated as a rigid or flexible/foldable security lid.

The security lid transforms the upper shopping cart storage area into a secure enclosed area and allows the customer to divert their attention to items on the shelf without worrying about potential theft.

An advantage of the invention is that it is inexpensive to manufacture, it can be made as an integral part of the shopping cart or as an add-on, and it a) enhances the customer's enjoyment of the shopping experience by reducing anxiety over potential theft, and b) may prevent actual theft.

Having discussed the invention in general, we turn now to a detailed discussion of the drawings.

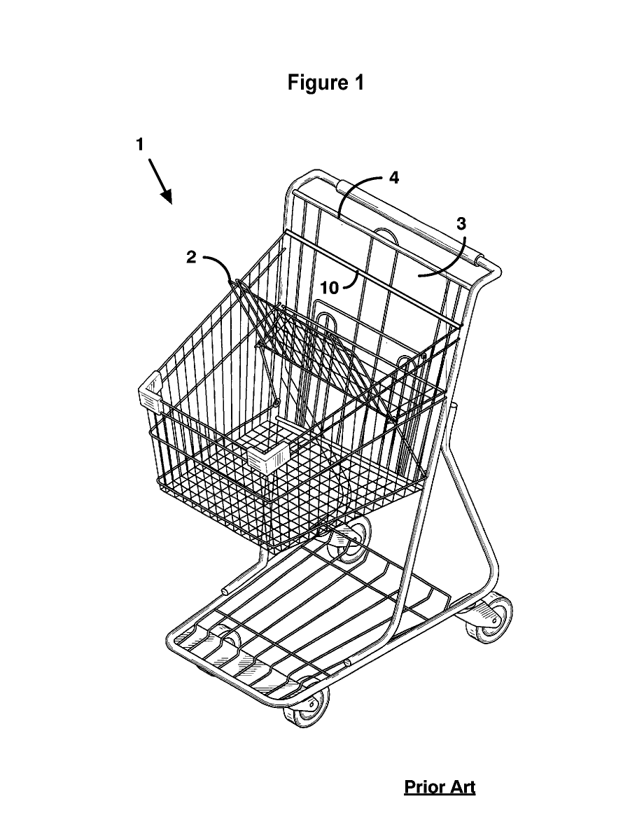

Regarding FIG. 1, this figure is a perspective view of a conventional shopping cart 1. This view also shows the fixed rear wall 4 and the pivoting rear wall 2 in the open position. When the pivoting rear wall 2 is moved to the open position, an upper shopping cart storage area 3 is made available for use by the customer. Typically, a shopper would place her purse, or perhaps other valuable items, in the upper shopping cart storage area 3 while shopping. Unfortunately, purses or other valuable items in the upper shopping cart storage area 3 are left exposed. As the shopper selects or examines merchandise, her attention is frequently diverted from the shopping cart to items on the merchant's shelf. When this happens, a thief is provided an opportunity to steal the handbag, or something within it, such as a wallet.

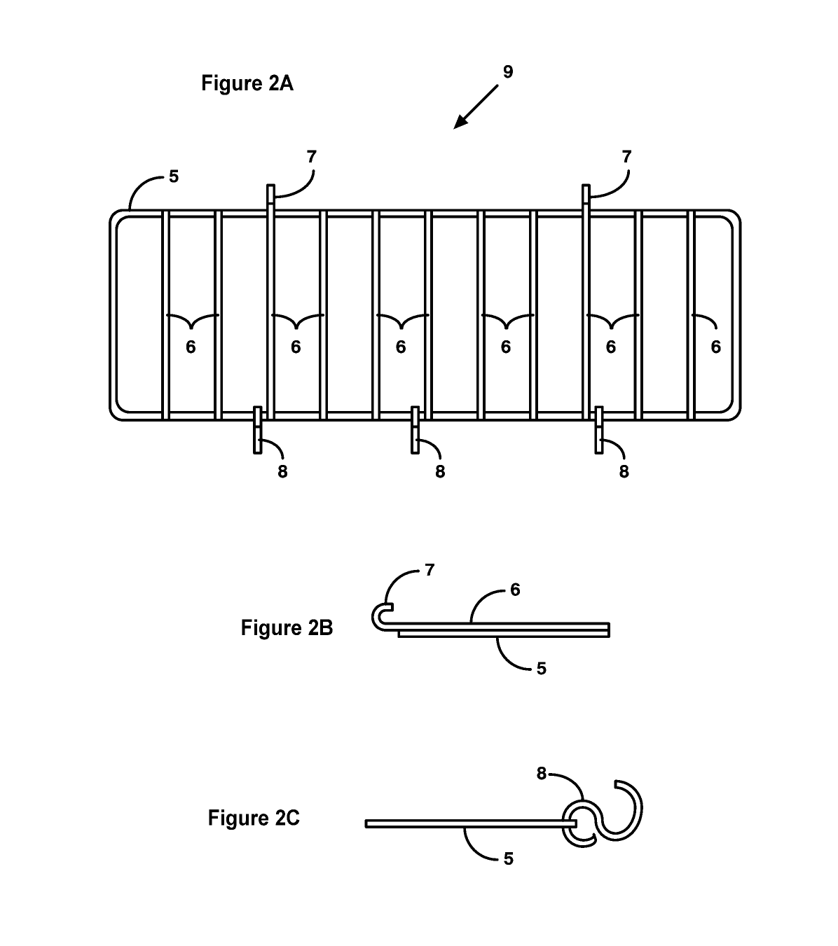

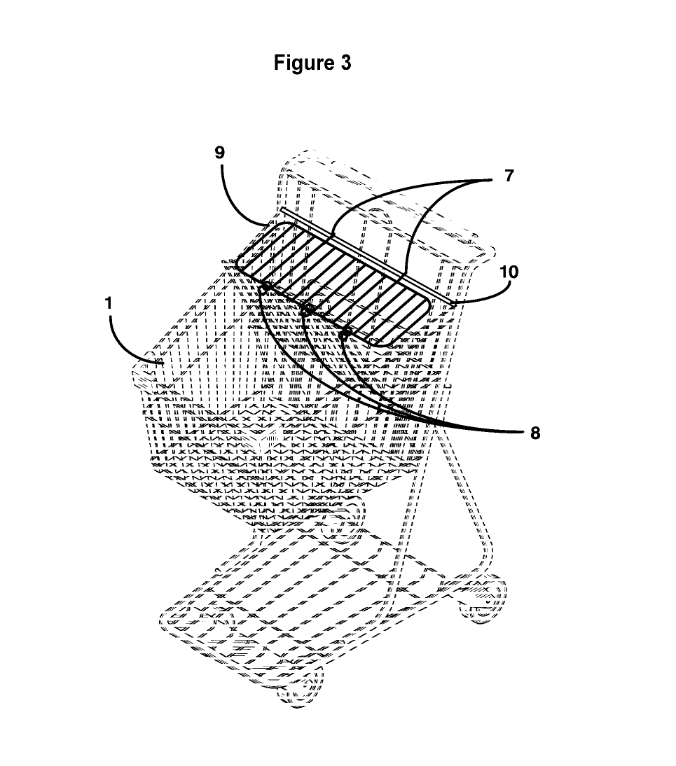

Also shown in this figure is attachment bar 10. A typical shopping cart will have one or more horizontal bars across the fixed rear wall 4. Any of these horizontal bars can be used as the attachment bar 10 that will be used to secure the security lid 9 in place (security lid 9 is discussed in more detail below in regard to FIGS. 2-3). The actual attachment bar 10 that is used will be selected based on how suitably it aligns with the security lid 9 to form the enclosed area formed by the security lid 9.

FIG. 2A is a top plan view of a preferred embodiment of the security lid 9. This can be seen in this figure, there is an outer bracket 5 that supports a plurality of rods 6. In the preferred embodiment, the distance between the rods 6 can vary so long as the distance is not so great as to allow a thief to slip a hand between the rods 6 or to allow an item such as a wallet to be slipped out between the rods 6.

Also shown in this figure are rods 6 that have attachment hooks 7 formed at one end. Attachment hooks 7 are sized such that they can engage any conveniently located attachment point on a shopping cart 1. Finally, rotatable hooks 8 are illustrated. In practice, the security lid 9 is stored in an open position when not in use such that the upper shopping cart storage area 3 can be accessed to remove or insert any item, such as a handbag. Typically, while the security lid 9 will preferably lay flat against the pivoting rear wall 2 when in the open position, those skilled in the art will recognize that the security lid 9 can alternatively be configured such that it can be secured to the fixed rear wall 4 of the shopping cart 1.

In the preferred embodiment, the rotatable hooks 8 are attached to the pivoting rear wall 2. In the open position, the security lid 9 will preferably rest flat against the pivoting rear wall 2. When in the closed position, the rotatable hooks 8 attach the security lid 9 to the pivoting rear wall 2 and the attachment hooks 7 are secured to the fixed rear wall 4 of the shopping cart 1 such that items in the upper shopping cart storage area 3 are securely enclosed. When securing the upper shopping cart storage area 3, the security lid 9 is held up by the customer and the pivoting rear wall 2 is moved toward the fixed rear wall 4 a sufficient distance to allow attachment hooks 7 to slide over a preselected rod in the fixed rear wall 4. Then the pivoting rear wall 2 is released and gravity pulls the pivoting rear wall 2 back such that the attachment hooks 7 engage the preselected rod in the fixed rear wall 4.

Prior art shopping carts typically have plastic seats in the upper shopping cart storage area 3 that flip down to allow a comfortable seat for children. When the security lid 9 is used, the plastic seats would preferably be flipped up to block the child's leg openings in the fixed rear wall 4 of the shopping cart 1, then the purse or other item would be placed in the secure compartment. After that, the security lid 9 is attached to fixed rear wall 4 and the purse is safely secured inside the shopping cart 1.

FIG. 2B is an end view of the security lid 9 that illustrates the outer bracket 5 with a rod 6 with an attachment hook 7 attached thereto. Those skilled in the art will recognize that any suitable materials may be used to fabricate the security lid 9. For example, metal, plastics, etc. In the case of metals, the outer bracket 5 and the rods 6 may be welded together. Further, fabrication from plastics or other materials will allow the bracket 5 and rods 6 to be fashioned as a single piece via a molding process.

FIG. 2C illustrates an end view of the security lid 9 that shows the bracket 5 and a rotatable hook 8. The rotatable hook 8 can be fabricated such that it can be removably or permanently attached to the pivoting rear wall 2 of the shopping cart 1.

For ease of discussion, the security lid 9 was discussed in terms of a rigid device. However, those skilled in the art will recognize that security lid 9 can also be implemented as a flexible device. For example, it can be fabricated from canvas, cloth, netting, etc. An alternative embodiment envisions a flexible security lid 9 that can be permanently attached to a shopping cart 1, or detachably attached to the shopping cart 1. A security lid 9 fabricated from flexible material provides an additional advantage in that a consumer can fold it up and carry it in a purse, a car glove compartment, etc. When the consumer visits a merchant location, the consumer's security lid 9 can be used with the merchant's shopping cart 1, even though the merchant's business may not provide security lids 9 on their shopping carts. This gives the consumer the independence to use the security lid 9 anywhere that uses shopping carts 1.

Another example of using a flexible security lid 9 is that it can be fabricated from stretchable material. This allows the consumer to attach the security lid 9 to shopping carts 1 that have different sizes.

FIG. 3 shows a perspective view of the security lid 9 secured to a conventional shopping cart 1. This figure illustrates the closed position in which a valuable such as a purse can be safely secured within the upper shopping cart storage area 3. As illustrated, security lid 9 is attached to pivoting rear wall 2 via rotatable hooks 8 and secured to fixed rear wall 4 via attachment hooks 7.

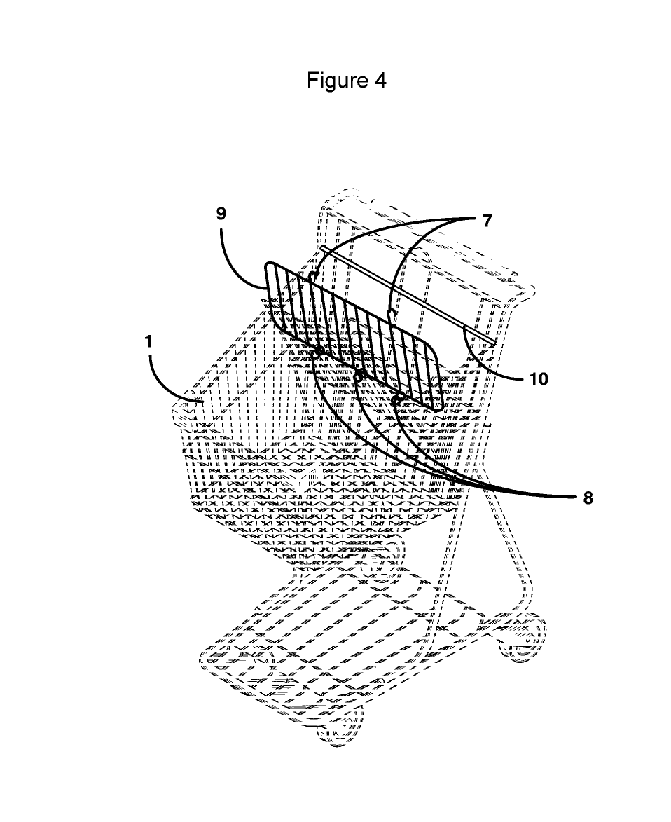

FIG. 4 shows a perspective view of the security lid 9 secured to a conventional shopping cart 1. This figure illustrates the open position in which the upper shopping cart storage area 3 is accessible. As illustrated, security lid 9 is attached to pivoting rear wall 2 via rotatable hooks 8. Attachment hooks 7 are unattached to fixed rear wall 4 in the open position. Also, the security lid 9 rests flat against pivoting rear wall 2 in this position. As a result, this allows a child to comfortably sit in the upper shopping cart storage area 3. Further, this allows multiple shopping carts 1 to be stacked together in the conventional manner.

For ease of illustration, this figure shows the security lid 9 positioned such that it extends upward from the shopping cart 1 in the open position. However, those skilled in the art will recognize that the security lid 9 can just as easily hang downward such that it rests substantially flat against the pivoting rear wall 4 of the shopping cart 1.

While specific embodiments have been discussed to illustrate the invention, it will be understood by those skilled in the art that variations in the embodiments can be made without departing from the spirit of the invention. For example, changes in material can be made, the dimensions of the security lid can change, the method used to secure the security lid to the shopping cart can change, etc. Therefore, the invention shall be limited solely to the scope of the claims.

I claim:

1. A security device for a shopping cart, comprising:
a security lid having means to attach to the pivoting rear wall of a shopping cart and the fixed rear wall of a shopping cart such that it limits access to an upper shopping cart storage area when in a closed position and permits access to the upper shopping cart storage area when in a closed position.

2. A device, as in claim 1, wherein:
the security lid is a rigid structure that extends from the pivoting rear wall of the shopping cart to the fixed read wall of the shopping cart, such that when attached, it securely encloses the upper shopping cart area.

3. A device, as in claim 2, wherein:
the security lid further comprises:
a first edge with first engagement means to engage the pivoting rear wall, and a second edge with second engagement means to engage the fixed rear wall, such that when the security lid is in the closed position, the first and second engagement means are respectively engaged with the pivoting and fixed rear walls; and
the second engagement means detachably engaged with the fixed rear wall such that when the second engagement means is detached from the fixed rear wall, the security lid is rotated to permit access to the upper shopping cart storage area.

4. A device, as in claim 2, wherein:
when the second engagement means is detached from the fixed rear wall, the security lid is rotated to rest against the pivoting rear wall.

5. A device, as in claim 3, wherein:
the first engagement means further comprises a plurality of rotatable hooks secured to the first edge, and further secured to the pivoting rear wall.

6. A device, as in claim 5, wherein:
the second engagement means further comprises at least two attachment hooks secured to the second edge, the attachment hooks detachably attached to the fixed rear wall when the security lid is in the closed position, and detached from the fixed rear wall when the security lid is in the open position.

7. A device, as in claim 5, wherein:
the second engagement means further comprises at least two hook and loop straps secured to the second edge, the hook and loop straps detachably attached to the fixed rear wall when the security lid is in the closed position, and detached from the fixed rear wall when the security lid is in the open position.

8. A device, as in claim 1, wherein:
the security lid is fabricated from flexible material that extends from the pivoting rear wall of the shopping cart to the fixed read wall of the shopping cart, such that when attached, it securely encloses the upper shopping cart storage area;
whereby the security lid is detachable from the shopping cart and is foldable to provide convenient storage or movement from one shopping cart to another.

9. A device, as in claim 8, wherein:
the security lid further comprises:
a first edge with first engagement means to engage the pivoting rear wall, and a second edge with second engagement means to engage the fixed rear wall, such that when the security lid is in the closed position, the first and second engagement means are respectively engaged with the pivoting and fixed rear walls; and
the second engagement means detachably engaged with the fixed rear wall such that when the second engagement means is detached from the fixed rear wall, it permits access to the upper shopping cart storage area, or when attached to the fixed rear wall, it prevents access to the upper storage area.

10. A device, as in claim 9, wherein:
the first engagement means further comprises a plurality of rotatable hooks secured to the first edge, and further secured to the pivoting rear wall.

11. A device, as in claim 10, wherein:
the second engagement means further comprises a plurality of attachment hooks secured to the second edge, the attachment hooks detachably attached to the fixed rear wall when the security lid is in the closed position, and detached from the fixed rear wall when the security lid is in the open position.

12. A device, as in claim 12, wherein:
the second engagement means further comprises at least two hook and loop straps secured to the second edge, the hook and loop straps detachably attached to the fixed rear wall when the security lid is in the closed position, and detached from the fixed rear wall when the security lid is in the open position.

13. A device, as in claim 13, wherein:
the security lid is fabricated from stretchable material such that it stretches to fit shopping carts having different sizes.

14. A method of protecting valuables in a shopping cart, including the step of:
attaching a security lid to a shopping cart that extends from the pivoting rear wall of the shopping cart to the fixed read wall of the shopping cart such that it securely encloses the upper shopping cart area;
whereby access to valuables in the upper shopping cart area is prevented.

15. A method, as in claim 13, including the additional step of:
using a rigid structure as the security lid.

16. A method, as in claim 15, including the additional step of:
attaching a first edge of the security lid to the pivoting rear wall with first engagement means, and attaching an opposing edge of the security lid to the fixed rear wall with second engagement means, such that when the security lid is in the closed position, the first and second engagement means are respectively attached to the pivoting and fixed rear walls.

17. A method, as in claim 16, including the additional step of:
using a plurality of attachment hooks secured to the second edge detachably attach the security lid to the fixed rear wall when the security lid is in the closed position.

18. A method, as in claim 17, including the additional step of:
using hook and loop straps to detachably attach the security lid to the fixed rear wall when the security lid is in the closed position.

19. A method, as in claim 14, including the additional steps of:
using a security lid that is substantially fabricated from flexible material that extends from the pivoting rear wall of the shopping cart to the fixed read wall of the shopping cart; and
detachably attaching the security lid to the shopping cart;
whereby the security lid is detachable from the shopping cart and is foldable to provide convenient storage or movement from one shopping cart to another.

20. A method, as in claim 19, including the additional step of:
fabricating the security lid from stretchable material such that it stretchably fits shopping carts having different sizes.
